(19) United States
(12) Patent Application Publication
(10) Pub. No.: US 2026/0261072 A1
(43) Pub. Date: Sep. 3, 2026

(54) CONNECTOR

(71) Applicants: FURUKAWA ELECTRIC CO., LTD., Tokyo (JP); FURUKAWA AUTOMOTIVE SYSTEMS INC., Inukami-gun (JP)

(72) Inventors: Takuto WADA, Tokyo (JP); Fumihito IMAMURA, Inukami-gun (JP); Hironori SHIRAHATA, Inukami-gun (JP)

(73) Assignees: FURUKAWA ELECTRIC CO., LTD., Tokyo (JP); FURUKAWA AUTOMOTIVE SYSTEMS INC., Inukami-gun (JP)

(21) Appl. No.: 19/655,791

(22) Filed: Apr. 23, 2026

Related U.S. Application Data
(63) Continuation of application No. PCT/JP2024/038321, filed on Oct. 28, 2024.

(30) Foreign Application Priority Data
Oct. 30, 2023 (JP) 2023-185488

(51) Int. Cl. H01R 13/52; H01R 13/02; H01R 13/502; H01R 13/629

(52) U.S. Cl. CPC H01R 13/5208; H01R 13/025; H01R 13/502; H01R 13/5202; H01R 13/62933

(57) ABSTRACT

The female housing 10 includes a holding portion main body 12 and a harness holding portion 11. A wire seal 7 attached to the harness holding portion 11, a seal retainer 8 inhibiting the wire seal 7 from coming off, and a cover 9 covering the seal retainer 8 are provided. The cover 9 has a retainer confirmation hole 94 and a second seal confirmation hole 95 formed therein, through which the seal retainer 8 and the wire seal 7 attached to the harness holding portion 11 are confirmed. The seal retainer 8 has a first seal confirmation hole 82 formed therein, through which the wire seal 7 is confirmed. The second seal confirmation hole 95 is configured such that the wire seal 7 is confirmed through the first seal confirmation hole 82 and the second seal confirmation hole 95.

### TECHNICAL FIELD

The present invention relates to a connector to be attached to, for example, a wire harness or the like and thus to be connected to a device such as a motor or the like.

### BACKGROUND ART

A piece of electric equipment mounted on an automobile or the like is connected to another piece of electric equipment or a power supply device via a wire harness including a bundle of covered electric wires to form an electric circuit. The wire harness, and the electric equipment or the power supply device, are connected to each other via connectors attached thereto.

For example, a harness-side connector as described in Patent Literature 1 is connected to a device-side connector provided in a device such as a motor or the like.

Specifically, a terminal of the connector provided on the harness side and a terminal of the connector provided on the device side are connected to each other to conductively connect the connectors to each other.

In one type of such a connector, a seal sealing a gap between a housing and an electric wire introduced into the housing, and a seal retainer preventing the seal from coming off, are located in the housing. This configuration prevents water from entering the inside of the housing and thus guarantees the waterproofness. However, if a connector in which the seal or the retainer is left unassembled is used, an inconvenience that, for example, water enters the inside of the housing to cause shortcircuiting may undesirably occur.

CITATION LIST PATENT LITERATURE Patent Literature 1: JP 2012-109035A1

### SUMMARY OF INVENTION

### TECHNICAL PROBLEM

The present invention has an object of providing a connector preventing a seal or a seal retainer from being left unassembled.

### SOLUTION TO PROBLEM

The present invention is directed to a connector to be fit into a counterpart connector to allow terminals provided in the connector and the counterpart connector to be connected to each other. The connector includes an electric wire having a terminal attached to a tip thereof; and a housing having the terminal located therein. The housing includes a terminal housing having the terminal located therein, and an electric wire holding portion being in communication with the terminal housing and holding the electric wire. The connector further includes a seal having an electric wire insertion hole formed therein, through which the electric wire is inserted, the seal being attached to the electric wire holding portion to seal a gap between the electric wire and the electric wire holding portion; a seal retainer attached to the electric wire holding portion to inhibit the seal from coming off from the electric wire holding portion; and a cover attached to the electric wire holding portion to cover the seal retainer. The cover has a confirmation portion formed therein, through which the seal retainer and the seal attached to the electric wire holding portion are confirmed from the outside of the connector in an attachment direction in which the seal retainer and the seal are attached to the electric wire holding portion. The seal retainer has a seal confirmation portion formed therein, through which the seal is confirmed. The confirmation portion is configured such that the seal is confirmed through the confirmation portion and the seal confirmation portion.

The confirmation portion and the seal confirmation portion may each be a through-hole or a cutout. Alternatively, the cover and the seal retainer may be partially or entirely formed of a highly visually recognizable material.

The confirmation portion and the seal confirmation portion may be configured such that confirmation is made by any of various methods including visual confirmation, confirmation by image processing, and confirmation of positions by use of laser light, a probe or the like.

According to this invention, the seal and the seal retainer are prevented from being left unassembled to the connector.

In more detail, the electric wire holding portion, which forms the housing together with the terminal housing having the terminal located therein and also holds the electric wire, has the electric wire insertion hole formed therein, through which the electric wire is inserted. The seal sealing the gaps between the electric wire and the electric wire holding portion, the seal retainer inhibiting the seal from coming off from the electric wire holding portion, and the cover covering the seal retainer are attached to the electric wire holding portion. The cover has the confirmation portion formed therein, through which the seal retainer and the seal attached to the electric wire holding portion are confirmed from the outside in the attachment direction in which the seal retainer and the seal are attached to the electric wire holding portion. The seal retainer has the seal confirmation portion formed therein, through which the seal is confirmed. The confirmation portion is configured such that the seal is confirmed through the confirmation portion and the seal confirmation portion. Therefore, in a state where the assembly of the housing is completed, the seal and the seal retainer located in the connector are confirmed from the outside of the connector through the confirmation portion.

That is, if at least one of the seal and the seal retainer is not confirmed through the confirmation portion, the at least one of the seal and the seal retainer is not assembled to the housing. Therefore, the seal and the seal retainer are prevented from being left unassembled to the connector. Thus, a situation is prevented where the connector having the seal or the seal retainer left unassembled thereto is used and as a result, water is inadvertently allowed to enter the inside of the connector to cause an inconvenience such that shortcircuiting or the like.

In an embodiment of the present invention, the seal confirmation portion may run through the seal retainer in the attachment direction.

According to this invention, the seal is confirmed through the confirmation portion having a simple configuration.

In an embodiment of the present invention, the confirmation portion may be a visual recognition window through which the seal is visually recognized from the outside of the connector in the attachment direction.

According to this invention, the shape of the window suppresses decrease in the strength of the cover as compared with the case where the confirmation portion is formed by cutout or the like.

In an embodiment of the present invention, the visual recognition window may run through the cover in the attachment direction.

According to this invention, the seal and the seal retainer are confirmed through the visual recognition window having a simple configuration.

The visual recognition window running through the cover in the attachment direction allows a stable waterproofing property to be guaranteed without the water-stopping property provided by the seal being decreased, unlike, for example, a confirmation hole extending in a direction in which the electric wire holding portion and the seal attached to the electric wire holding portion contact each other.

In an embodiment of the present invention, the seal confirmation portion provided in the seal retainer is a retainer-side seal confirmation portion. The confirmation portion includes a cover-side retainer confirmation portion through which the seal retainer is confirmed, and a cover-side seal confirmation portion through which the seal is confirmed via the retainer-side seal confirmation portion.

According to this invention, the seal is confirmed from the outside through the cover-side seal confirmation portion provided in the cover and the retainer-side seal confirmation portion, and the seal retainer is confirmed from the outside through the cover-side retainer confirmation portion. Therefore, the cover-side retainer confirmation portion and the retainer-side seal confirmation portion allow the seal retainer and the seal to be confirmed independently from each other. Thus, it is confirmed with certainty that the seal and the seal retainer are attached to the inside of the electric wire holding portion.

In an embodiment of the present invention, the connector may include a plurality of the wires, and a plurality of the seals, a plurality of the seal retainers, and a plurality of the covers provided by a number in accordance with the number of the plurality of electric wires.

According to this invention, the connector is assembled easily.

In more detail, each one of the wire harnesses is inserted into each one of the plurality of seals, each one of the plurality of seal retainers and each one of the plurality of covers, provided by a number in accordance with the number of the electric wires, and thus the seals, the seal retainers and the covers are attached to the housing in the attachment direction. Therefore, as compared with the case where the plurality of electric wires are inserted through one seal, one seal retainer and one cover for assembly, the operability of the seals, the seal retainers and the covers is improved and thus the ease of assembly of the connector is improved.

In an embodiment of the present invention, the connector may further comprise engaging securing portions respectively engaged with the covers to secure the covers to the housing.

According to this invention, the cover is attached to, and secured to, the housing easily. The engaging protrusions may be disengaged, so that the cover attached to the housing is detached. Therefore, in the case where it is found out that the seal or the seal retainer is left unassembled by the confirmation made by use of the confirmation portion, the cover is detached from the housing and the seal or the seal retainer is attached easily in the attachment direction.

In an embodiment of the present invention, the electric wires may each include a shield layer enclosing a conductor. The housing may house shield shells respectively enclosing the terminals. The shield layers and the shield shells may be respectively conductive to each other.

According to this invention, the connector of an inner shield type is provided.

Particularly in the case of the inner shield-type connector, the gap between the shield shell and the housing is not sealed, unlike in the case of an outer shield-type connector, in which a shield shell encloses an outer surface of the connector. Therefore, the seal attached to the inside of the housing in the attachment direction to seal the gap, and the seal retainer preventing the seal from coming off, need to be provided additionally. However, the seal and the seal retainer attached to the housing are confirmed from the outside. Therefore, the seal and the seal retainer are prevented from being left unassembled. Thus, the inner shield-type connector is assembled with certainty.

### ADVANTAGEOUS EFFECTS OF INVENTION

The present invention provides a connector preventing a seal or a seal retainer from being left unassembled.

### BRIEF DESCRIPTION OF DRAWINGS

FIG. 1 is a schematic perspective view of a connector connection structure.

FIG. 2 is a schematic perspective view of the connector connection structure in a divided state.

FIG. 3 is a schematic perspective view of the connector connection structure in a divided state.

FIG. 4 is an schematic exploded perspective view of a harness-side connector.

FIG. 5 is an schematic exploded perspective view of the harness-side connector.

FIG. 6A is a schematic front view of a female housing as seen from a rear side Db

FIG. 6B is a schematic side view of the female housing as seen from a right side Wr.

FIG. 7A is a schematic bottom view of the female housing as seen from a bottom side Hd.

FIG. 7B is a schematic enlarged view of part b in FIG. 4.

FIG. 8 is a schematic enlarged front view of the female housing.

FIG. 9A is a schematic bottom view of a wire seal as seen from the bottom side Hd

FIG. 9B is a cross-sectional view of FIG. 9A taken along line A-A.

FIG. 10A is a schematic bottom view of a seal retainer as seen from the bottom side Hd.

FIG. 10B is a cross-sectional view of FIG. 10A taken along line B-B.

FIG. 10C is a cross-sectional view of FIG. 10A taken along line C-C.

FIG. 11A is a schematic bottom view of a cover as seen from the bottom side Hd.

FIG. 11B is a cross-sectional view of FIG. 11A taken along line D-D.

FIG. 11C is a cross-sectional view of FIG. 11A taken along line E-E.

FIG. 12 is a schematic bottom view of the harness-side connector in an assembled state.

FIG. 13A is a schematic enlarged cross-sectional view of FIG. 12 taken along line F-F.

FIG. 13B is a schematic enlarged cross-sectional view of FIG. 12 taken along line G-G.

FIG. 14 is a schematic bottom view of a harness-side connector according to another embodiment.

FIG. 15 is a cross-sectional view of FIG. 14 taken along line H-H.

### DESCRIPTION OF EMBODIMENTS

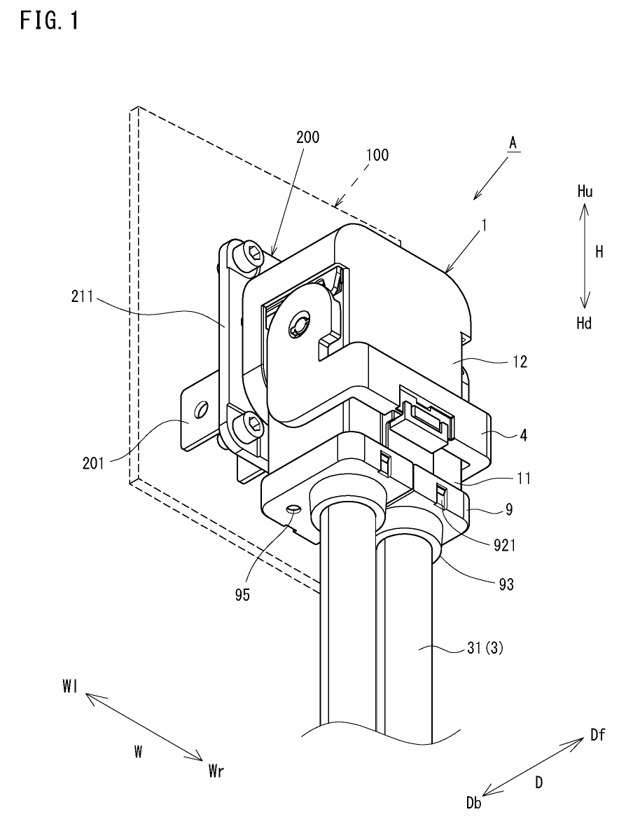

Hereinafter, an embodiment of the present invention will be described with reference to FIG. 1 through FIG. 13.

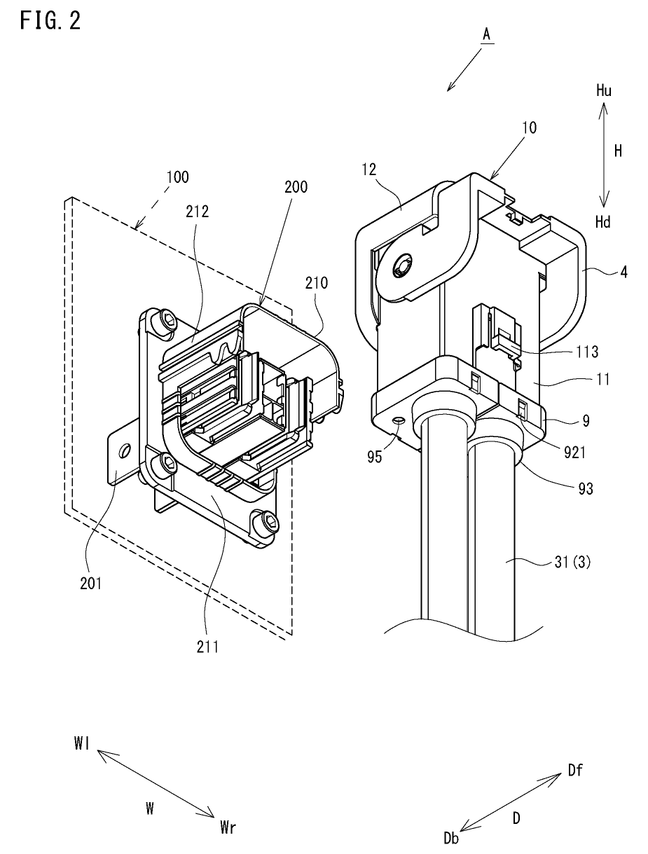

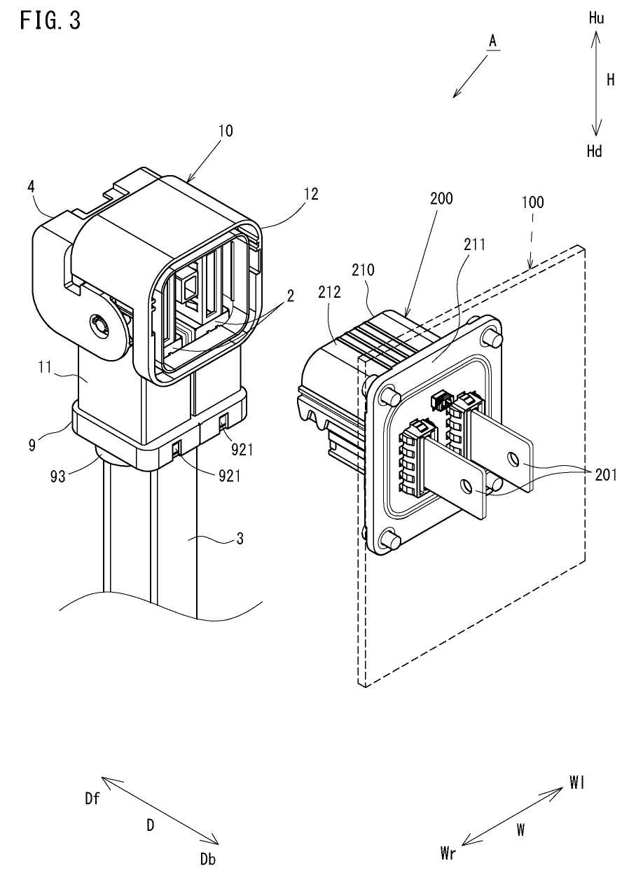

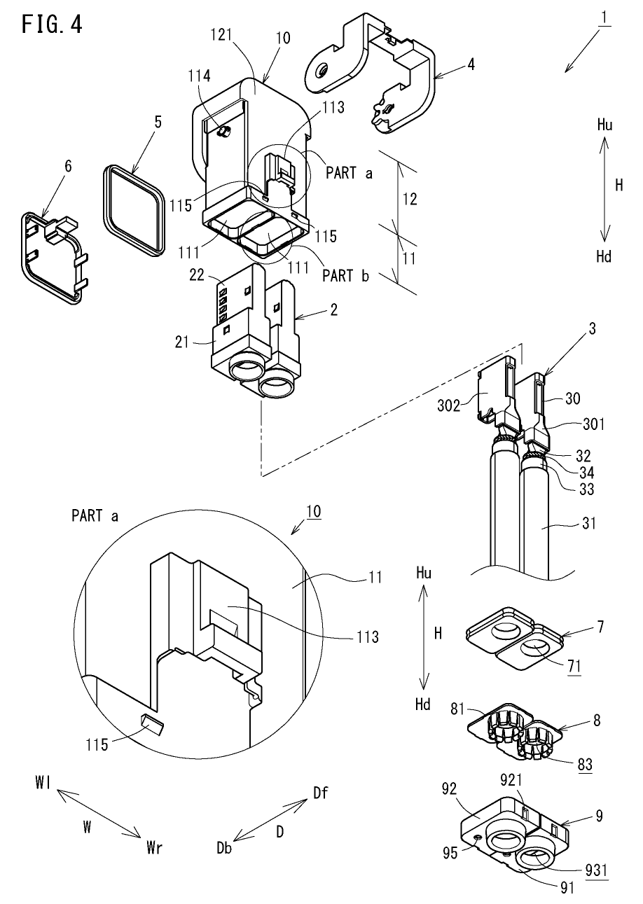

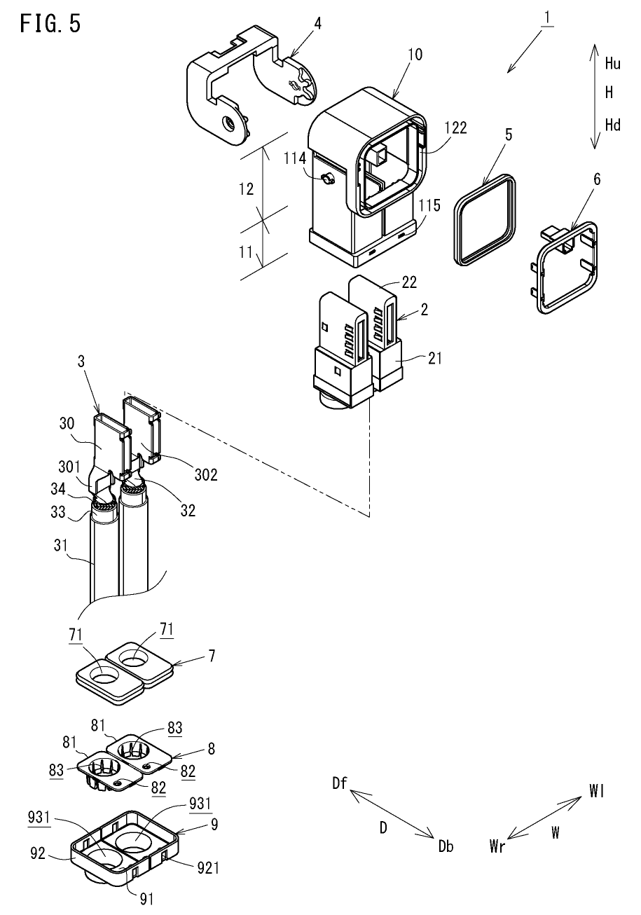

FIG. 1 is a schematic perspective view of a connector connection structure A. FIG. 2 is a schematic perspective view of the connector connection structure A in a divided state as seen from a bottom side Hd. FIG. 3 is a schematic perspective view of the connector connection structure A in a divided state as seen from a top side Hu. FIG. 4 is a schematic exploded perspective view of a harness-side connector 1 as seen from the bottom side Hd. FIG. 5 is a schematic exploded perspective view of the harness-side connector 1 as seen from the top side Hu. In FIG. 4 and FIG. 5, shield layers 34 are shown as being partially exposed in order to clearly show a configuration of wire harnesses 3.

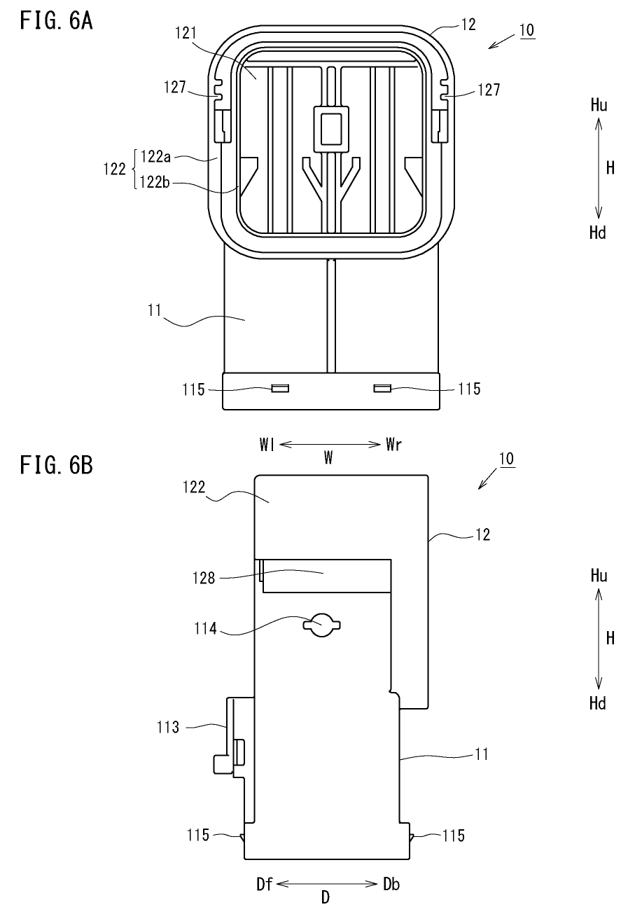

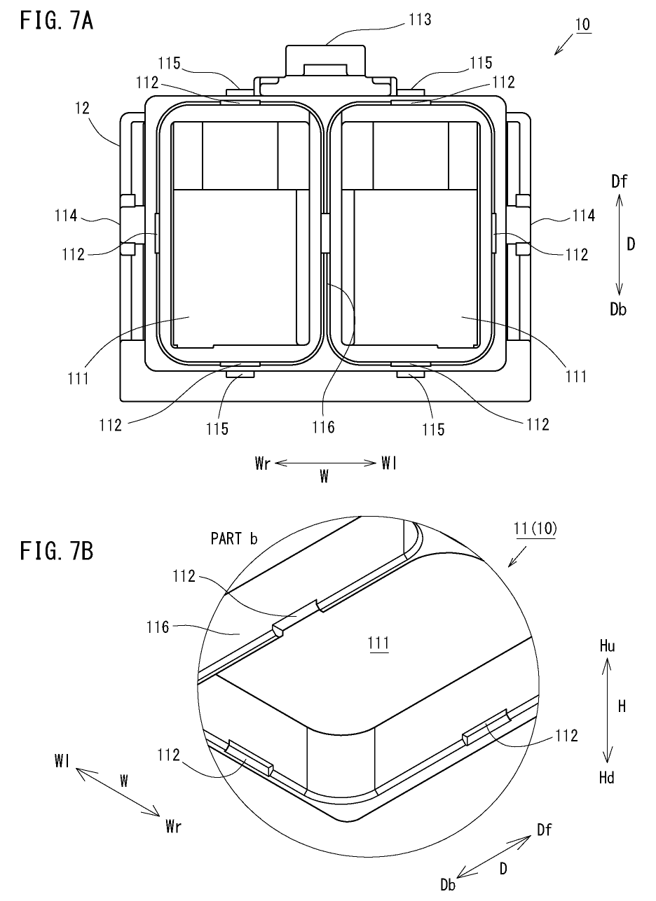

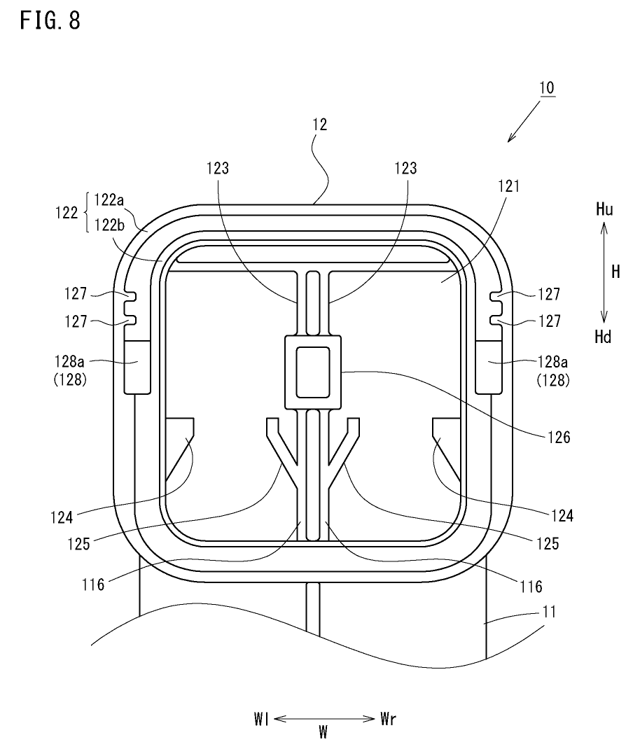

FIG. 6A is a schematic front view of a female housing 10 as seen from a rear side Db, and FIG. 6B is a schematic side view of the female housing 10 as seen from a right side Wr. FIG. 7A is a schematic bottom view of the female housing 10 as seen from the bottom side Hd, and FIG. 7B is a schematic enlarged view of part b in FIG. 4. FIG. 8 is a schematic enlarged front view of a holding portion main body 12.

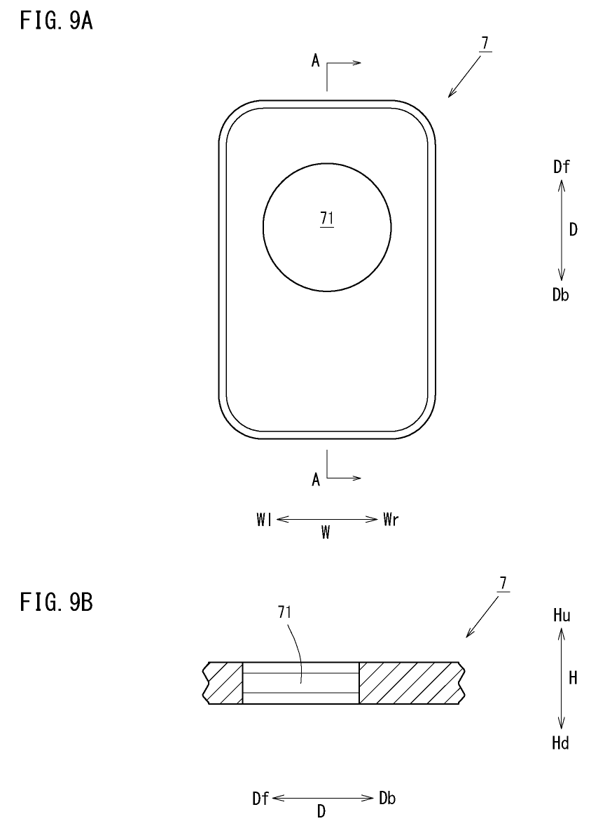

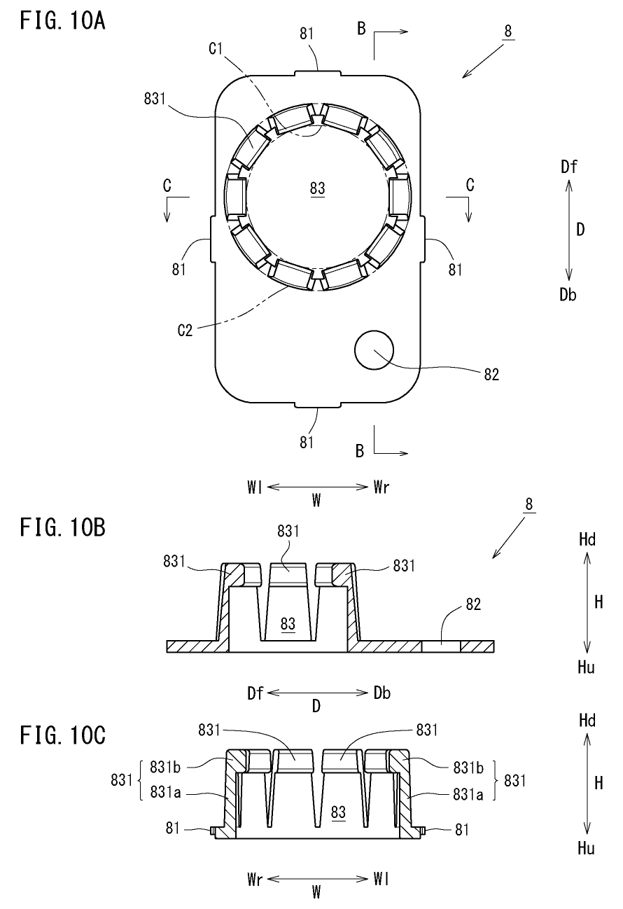

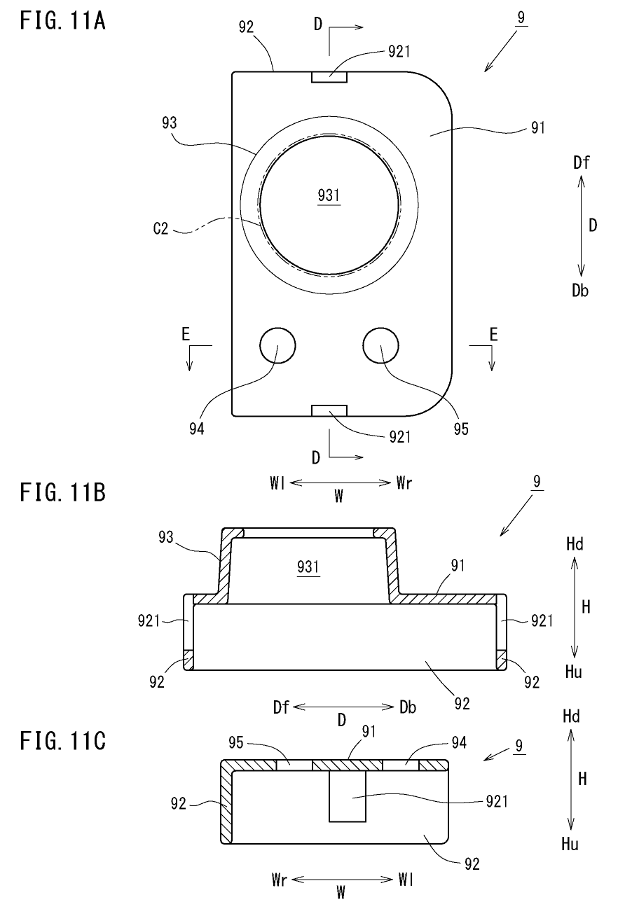

FIG. 9A is a schematic bottom view of a wire seal 7 as seen from the bottom side Hd, and FIG. 9B is a cross-sectional view of FIG. 9A taken along line A-A. FIG. 10A is a schematic bottom view of a seal retainer 8 as seen from the bottom side Hd. FIG. 10B is a cross-sectional view of FIG. 10A taken along line B-B, and FIG. 10C is a cross-sectional view of FIG. 10A taken along line C-C. FIG. 11A is a schematic bottom view of a cover 9 as seen from the bottom side Hd. FIG. 11B is a cross-sectional view of FIG. 11A taken along line D-D, and FIG. 11C is a cross-sectional view of FIG. 11A taken along line E-E.

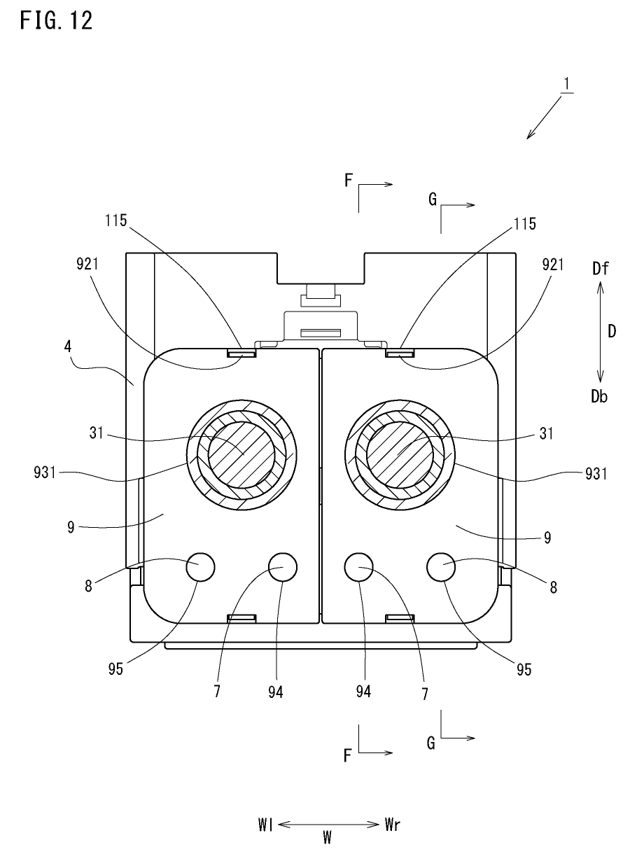

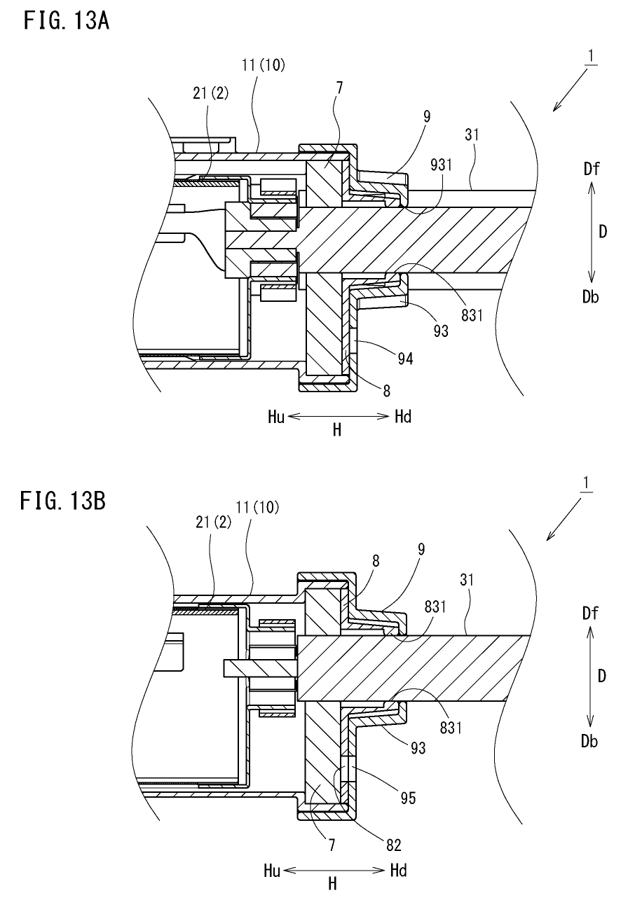

FIG. 12 is a schematic bottom view of the harness-side connector 1 in an assembled state as seen from the bottom side Hd. FIG. 13A is a schematic enlarged cross-sectional view of FIG. 12 taken along line F-F, and FIG. 13B is a schematic enlarged cross-sectional view of FIG. 12 taken along line G-G.

Herein, referring to FIG. 1, a direction in which the harness-side connector 1 and a device-side connector 200 are attached to, or detached from, each other will be referred to as a front-rear direction D. A side toward which the harness-side connector 1 is attached to the device-side connector 200 will be referred to as a "rear side Db", and a side toward which the harness-side connector 1 is detached from the device-side connector 200 will be referred to as a "front side Df". Directions perpendicular to the front-rear direction D will be referred to as a "width direction W" and a "height direction H". Regarding the width direction W, a left side will be referred to as a "left side Wl", and a right side will be referred to as the "right side Wr". Referring to FIG. 1, a top side will be referred to as the "top side Hu", and a bottom side will be referred to as the "bottom side Hd". These directions and sides will be applied to FIG. 2 through FIG. 13.

However, these directions and sides do not define directions or sides regarding the configuration of the harness-side connector 1, the device-side connector 200 or the connector connection structure A.

As shown in FIG. 1 through FIG. 3, the connector connection structure A is a connection structure by which, for example, the harness-side connector 1 attached to the wire harnesses 3 each including a bundle of covered electric wires, and the device-side connector 200 provided in a device such as a motor or the like provided in an automobile or the like, are fit into each other and thus electrically connected to each other.

First, the device-side connector 200 connected to the harness-side connector 1 described below to form the connector connection structure A will be briefly described.

As shown in FIG. 2 and FIG. 3, the device-side connector 200 includes two device-side terminals 201 and a male housing 210 housing the device-side terminals 201.

The device-side terminals 201 are each a flat metal plate having a rectangular shape longer in the front-rear direction D, and are electrically connected to an electric device main body (not shown) located in a housing 100. Two such device-side terminals 201 are provided such that main surfaces thereof extending in the front-rear direction D and the height direction H face each other while being away from each other by a predetermined interval in the width direction W.

The male housing 210 holds the device-side terminals 201 therein, and includes a secured base 211 secured to the housing 100 described below and a hood 212 standing from the secured base 211.

The secured base 211 has a plate-like body of a generally rectangular shape as seen in a front view, that is, as seen in a direction in which the harness-side connector 1 is inserted into the device-side connector 200 (as seen from the front side Df).

The hood 212 is a substantially ring-shaped wall extending toward the front side Df from the secured base 211 so as to enclose a central portion of the secured base 211.

As shown in FIG. 2 and FIG. 3, the device-side connector 200, including the device-side terminals 201 held in the hood 212 of the male housing 210, is to be assembled to the housing 100 of a device such as a motor or the like provided in an automobile or the like.

Now, the harness-side connector 1 connected to the device-side connector 200, assembled to the housing 100 of the device such as a motor or the like provided in an automobile or the like as described above, to form the connector connection structure A will be described.

As shown in FIG. 4 and FIG. 5, the harness-side connector 1 includes the female housing 10 shaped like a box, shield shells 2 housed in the female housing 10, the wire harnesses 3 inserted through the female housing 10, an engaging lever 4 attached to the female housing 10, a housing seal 5, a housing seal cover 6, the wire seals 7, the seal retainers 8, and the covers 9.

As shown in FIG. 4 through FIG. 6B, the female housing 10 is shaped like a box having openings on the bottom side Hd and on the rear side Db. The female housing 10 includes a tubular harness holding portion 11 and a holding portion main body 12 provided on the top side Hu of the harness holding portion 11. The harness holding portion 11 and the holding portion main body 12 are integrated with each other.

The harness holding portion 11 is a tubular member of a rectangular shape, as seen in a bottom view, that is slightly longer in the width direction W than in the front-rear direction D. As shown in FIG. 7A, the harness holding portion 11 includes two insertion holes 111 running therethrough in the height direction H, engaging recessed portions 112 and engaging protrusions 115 provided at a bottom end of the harness holding portion 11, an engaging connection portion 113 provided on an outer surface on the front side Df of the harness holding portion 11, and engaging shafts 114 respectively provided on two side surfaces in the width direction W of the harness holding portion 11.

The insertion holes 111 are rectangular holes, as seen in a bottom view, that are longer in the front-rear direction D than in the width direction W. Two such insertion holes 111 are lined up in the width direction W. The two insertion holes 111 lined up in the width direction W are partitioned from each other by a partition wall 116.

As shown in FIG. 7A and FIG. 7B, the engaging recessed portions 112 are each a part, of an inner surface facing the insertion hole 111 at the bottom end of the harness holding portion 11, that is recessed toward the top side Hu. The engaging recessed portions 112 are respectively formed to be sufficiently large to allow engaging extending portions 81 of the seal retainers 8 described below to be located therein.

The engaging recessed portions 112 are provided at the bottom end of the harness holding portion 11 having a rectangular shape, as seen in a bottom view, that is slightly longer in the width direction W than in the front-rear direction D; more specifically, are each provided at a center of each side of the insertion hole 111 having a rectangular shape, as seen in a bottom view, that is longer in the front-rear direction D than in the width direction W. Specifically, the engaging recessed portions 112 are provided at the bottom end of the harness holding portion 11 having a rectangular shape, as seen in a bottom view, that is slightly longer in the width direction W than in the front-rear direction D; more specifically, at a center in the front-rear direction D of each of the two sides extending in the front-rear direction D, at two positions in each of two sides extending in the width direction W, and at a center of the partition wall 116 extending in the front-rear direction D. Thus, a total of seven such engaging recessed portions 112 are provided. The two positions in each of the two sides extending in the width direction W are away from each other by a predetermined interval.

As shown in the enlarged view of part a of FIG. 4, the engaging connection portion 113 is generally shaped like a box opened on the bottom side Hd. The engaging lever 4 described below is inserted into the engaging connection portion 113 from the bottom side Hd, and thus the engaging connection portion 113 is engageable with the engaging lever 4.

The engaging connection portion 113 includes a pair of protrusion pieces protruding from the harness holding portion 11 and a coupling body coupling tips of the protrusion pieces to each other in the width direction W. The engaging connection portion 113 is provided in a central portion in the width direction W of an outer side surface on the front side Df of the harness holding portion 11.

The engaging shafts 114 are support portions rotatably supporting the engaging lever 4 described below, and generally cylindrical members protruding outward in the width direction W from two sides surfaces in the width direction W of the harness holding portion 11. In more detail, the engaging shafts 114 each include a cylinder protruding in the width direction W from the side surface in the width direction W of the harness holding portion 11 and protruding portions protruding in the front-rear direction D from both of two ends in the front-rear direction D of the cylinder such that the protruding portions are rectangular (see FIG. 6B).

Two such engaging shafts 114 thus configured are respectively provided on both of the two side surfaces in the width direction W of the harness holding portion 11; more specifically, at positions on the top side Hu with respect to the engaging connection portion 113. The two engaging shafts 114 are provided at positions facing each other in the width direction W.

The engaging protrusions 115 are securing portions engaged with the covers 9 described below to secure the covers 9. As shown in the enlarged view of part a of FIG. 4 and FIG. 7A, the engaging protrusions 115 are formed to protrude in the front-rear direction D from the side surfaces on the front side Df and the rear side Db of the harness holding portion 11.

Specifically, the engaging protrusions 115 each have a generally horizontal surface on the top side Hu and a surface on the bottom side Hd inclining outward in the front-rear direction D toward the top side Hu. Four engaging protrusions 115 thus configured are respectively provided at four positions in the vicinity of bottom ends of surfaces extending in the width direction W of the harness holding portion 11; more specifically, at two positions in each of the surfaces extending in the width direction W. Such two positions are away from each other by a predetermined interval in the width direction W.

The holding portion main body 12 forming the female housing 10 together with the harness holding portion 11 and located on the top side Hu of the harness holding portion 11 is shaped like a box having openings on the bottom side Hd and on the rear side Db. The holding portion main body 12 includes a housing bottom surface portion 121 located on the front side Df and extending in the height direction H, and a housing side wall 122 standing from the housing bottom surface portion 121.

The holding portion main body 12 is formed to be longer than the harness holding portion 11 in the front-rear direction D, and an end surface on the front side Df thereof is flush with the harness holding portion 11 as seen in a side view. Therefore, the holding portion main body 12 protrudes toward the rear side Db from an end on the top side Hu of the harness holding portion 11 (see FIG. 6B).

The housing bottom surface portion 121 has a thickness generally equal to the thickness of a plate-like member forming the harness holding portion 11, and is formed to be generally square as seen from the rear side Db. The housing bottom surface portion 121 is located on the front side Df of the holding portion main body 12. As shown in FIG. 8, the housing bottom surface portion 121 has, provided thereon, a pair of extending walls 123 extending toward the top side Hu from the partition wall 116 of the harness holding portion 11 and restriction protrusions 124 facing the extending walls 123 in the width direction W.

The extending walls 123 provided on the housing bottom surface portion 121 stand from the housing bottom surface portion 121 by a predetermined length. The extending walls 123 include first engaging ribs 125 protruding outward and a protrusion 126, which is a cylindrical member protruding toward the rear side Db. The extending walls 123 stand by a height that is approximately 1/4 of the length in the front-rear direction D of the holding portion main body 12.

The first engaging ribs 125 respectively incline to be away from the extending walls 123 toward the top side Hu, and each include a surface, at a tip thereof, that is along the width direction W (see FIG. 6A).

The protrusion 126 is provided on the top side Hu with respect to the first engaging ribs 125, and has a cuboid shape that is tubular as seen in a front view. The protrusion 126 protrudes by a predetermined length from the housing bottom surface portion 121 toward the opening on the rear side Db of the holding portion main body 12.

The restriction protrusions 124 provided on the housing bottom surface portion 121 are each formed to have a generally triangular cross-section, and each include a surface extending in the width direction W and a surface inclining outward in the width direction W toward the bottom side Hd. The restriction protrusions 124 are respectively provided at positions, on the housing bottom surface portion 121, facing the first engaging ribs 125 in the width direction W.

The housing side wall 122 forming the holding portion main body 12 together with the housing bottom surface portion 121 stands toward the rear side Db from an outer perimeter of the housing bottom surface portion 121. As shown in FIG. 8, the housing side wall 122 has a double-wall structure including an outer wall 122a and an inner wall 122b located inner to the outer wall 122a.

The outer wall 122a has a predetermined thickness, and includes ribs 127 protruding in the width direction W and insertion windows 128, which are each a cutout part of the outer wall 122a. The holding portion main body 12 has the opening on the bottom side Hd as described above, and therefore, a part, of the outer wall 122a, that is located on the bottom side Hd is provided only at a position at which the holding portion main body 12 protrudes from the harness holding portion 11.

The ribs 127 protrude by a predetermined length from an inner surface of the outer wall 122a toward the inner wall 122b, and are formed in the entire length in the front-rear direction D of the holding portion main body 12. Four ribs 127 thus configured are respectively provided at four positions, specifically, at two positions in the vicinity of a top end of each of two surfaces extending in the height direction H of the outer wall 122a. Such two positions are away from each other by a predetermined interval in the height direction H. The two positions in one of the two surfaces and the two positions in the other of the two surfaces face each other in the width direction W.

The insertion windows 128 are formed by cutting out the outer wall 122a in the front-rear direction D. In more detail, the insertion windows 128 are formed by cutting out parts of the outer wall 122a on the bottom side Hd with respect to the ribs 127, each by a length generally equal to the length in the front-rear direction D of the harness holding portion 11. Two insertion windows 128 thus configured are respectively provided at two positions, in the outer wall 122a, facing each other in the width direction W.

As shown in FIG. 8, as a result of the provision of the insertion windows 128, insertion spaces 128a each having a generally rectangular shape as seen in a front view are formed between the outer wall 122a and the inner wall 122b, at positions on the bottom side Hb with respect to the ribs 127.

The inner wall 122b has a rectangular shape slightly smaller than the rectangular shape of the outer wall 122a. Like the outer wall 122a, a part, of the inner wall 122b, that is located on the bottom side Hd is provided only at a position at which the holding portion main body 12 protrudes from the harness holding portion 11.

Between the outer wall 122a and the inner wall 122b thus configured, a space generally having a rectangular frame shape with arced corners as seen in a front view is formed.

As can be seen, the holding portion main body 12 including the housing bottom surface portion 121 and the housing side wall 122 (122a, 122b) is opened on the rear side Db, and has an inner space on the bottom side Hd in communication with the insertion holes 111.

The shield shells 2 housed in the harness-side connector 1 are each shaped like a box tapering toward a tip thereof, and each include a tubular harness insertion portion 21 and a box-shaped terminal holding portion 22 provided on the top side Hu of the harness insertion portion 21. The harness insertion portion 21 and the terminal holding portion 22 of each shield shell 2 are integrated with each other. The shield shells 2 are formed of a conductive material.

The shield shells 2 thus configured each house a harness-side terminal 30 of each wire harness 3 described below, and are each conductively connected to the shield layer 34 of a shield electric wire 31 to provide a shield function.

As shown in FIG. 4 and FIG. 5, the wire harnesses 3 each include the harness-side terminal 30 and the shield electric wire 31 connected to the harness-side terminal 30.

The shield electric wire 31 includes a conductive core wire 32, an insulating inner cover layer 33, the shield layer 34 formed of weaved metal wires such as copper wires or the like, and an insulating outer cover layer 35 located in this order in a radially outward direction from a center of the shield electric wire 31.

At an end on the top side Hu of each shield wire 31, the outer cover layer 35 is exfoliated to expose the shield layer 34. As described above, the shield wires 31 are respectively conductive to the shield shells 2. The shield layers 34 are not limited to being formed of weaved metal wires, and may be formed of a metal foil or the like.

As shown in FIG. 4 and FIG. 5, the harness-side terminals 30 each include an electric wire connection portion 301 connected to the end on the top side Hu of the shield electric wire 31 and a terminal connection portion 302.

The terminal connection portions 302 each include a pair of side walls facing each other in the width direction W. In a state where the terminal connection portion 302 is connected to the device-side connector 200, the device-side terminal 201 enters between the pair of side walls and thus connects the pairs of side walls to each other.

Two wire harnesses 3 thus configured are lined up in the width direction W (see also FIG. 4 and FIG. 5).

The engaging lever 4 is assembled to the female housing 10 by being pivotably supported by the engaging shafts 114. The engaging lever 4 secures a state where the female housing 10 is connected to the device-side connector 200.

The engaging lever 4 is generally shaped like a gate as seen in a plan view, and is formed to have a general U shape with angular corners as seen in a plan view and to be generally L-shaped as seen in a side view.

The female housing 10 includes the housing seal 5 sealing a gap between the female housing 10 and the device-side connector 200 in a state where the female housing 10 and the device-side connector 200 are connected to each other, and the housing seal cover 6 preventing the housing seal 5 from coming off.

The wire seals 7 are assembled to the female housing 10 having the wire harnesses 3 inserted through, and thus seal gaps between the shield electric wires 31 inserted through the insertion holes 111 and the harness holding portion 11.

As shown in FIG. 9A, each of the wire seals 7 is a plate-like rubber member having generally the same shape as that of an outer perimeter of the insertion hole 111 as seen in a plan view, and has a circular seal hole 71 formed therein.

As seen in a plan view of the wire seal 7, the seal hole 71 is provided on the front side Df with respect to a center thereof in the front-rear direction D. The seal hole 71 has an inner diameter that is generally equal to an outer diameter of the shield electric wire 31.

In this embodiment, two wire harnesses 3 are provided. Therefore, two wire seals 7 are provided in accordance with the number of the wire harnesses 3. The two wire seals 7 are lined up in the width direction W in a state of being attached to the harness holding portion 11 of the female housing 10 (see FIG. 4 and FIG. 5).

The seal retainers 8 are stacked on the wire seals 7 assembled to the female housing 10 to prevent the wire seals 7 from coming off from the insertion holes 111 and to hold the wire harnesses 3 inserted therethrough.

As shown in FIG. 10A, each of the seal retainers 8 is a plate-like member having substantially the same shape as that of the wire seal 7 as seen in a plan view. The seal retainer 8 includes engaging extending portions 81 protruding outward, a circular first seal confirmation hole 82 running through the seal retainer 8 in a thickness direction thereof (in the height direction H), and an electric wire insertion hole 83, through which the shield electric wire 31 of the wire harness 3 is inserted.

The engaging extending portions 81 are each a rectangular piece that is a part, of an outer perimeter of the seal retainer 8, that extends by a predetermined length. Specifically, each engaging extending portion 81 is formed to be slightly smaller than the engaging recessed portion 112 as seen in a plan view. Four such engaging extending portions 81 are respectively provided at four positions facing the engaging recessed portion 112 in the height direction H in a state where the seal retainer 8 is assembled to the female housing 10.

As shown in FIG. 10A and FIG. 10B, the first seal confirmation hole 82 is a circular through-hole formed in the vicinity of a corner of the seal retainer 8 on the rear side Db and the right side Wr, that is, located away from the outer perimeter of the seal retainer 8 and away from the electric wire insertion hole 83.

The electric wire insertion hole 83 is a hole having a diameter larger than that of the first seal confirmation hole 82 as seen in a plan view of the seal retainer 8. Specifically, the electric wire insertion hole 83 is formed to have an inner diameter that is slightly larger than the outer diameter of the shield electric wire 31. The electric wire insertion hole 83 is provided on the side of the front side Df with respect to a center in the front-rear direction D of the seal retainer 8 as seen in a plan view, that is, provided at a position facing the seal hole 71 in the height direction H in a state where the seal retainer 8 is assembled to the female housing 10. A plurality of elastic pieces 831 protrude from an inner perimeter of the electric wire insertion hole 83.

As shown in FIG. 10C, the elastic pieces 831 each include a plate 831a protruding toward the top side Hu and a block 831b provided at a tip of the plate 831a. The plate 831a and the block 831b are integrated with each other. The seal retainer 8 including the elastic pieces 831 is formed of a material that is flexible and elastic.

Ten elastic pieces 831 thus configured are respectively provided at ten positions at an equal interval through the entirety of the inner perimeter of the electric wire insertion hole 83 in a circumferential direction thereof. A phantom circle formed by inner edges of the blocks 831b (the phantom circle is referred to as a "first phantom circle C1") has a diameter that is slightly smaller than the outer diameter of the shield electric wire 31 (see FIG. 10A).

In this embodiment, two wire harnesses 3 are provided. Therefore, two seal retainers 8 are provided in accordance with the number of the wire harnesses 3. The two seal retainers 8 are lined up in the width direction W in a state of being attached to the harness holding portion 11 of the female housing 10 (see FIG. 4 and FIG. 5).

The covers 9 are assembled to the female housing 10 to cover the insertion holes 111 each having the wire seal 7 and the seal retainer 8 inserted therethrough.

As shown in FIG. 11A and FIG. 11B, each of the covers 9 includes a cover bottom surface portion 91 extending in the front-rear direction D and a cover side wall 92 standing from the cover bottom surface portion 91. The cover bottom surface portion 91 and the cover side wall 92 are integrated with each other.

The cover bottom surface portion 91 is a generally rectangular plate-like member larger than the insertion hole 111 as seen in a plan view, and includes a cover protrusion 93, which is a part of the cover bottom surface portion 91 protruding in a cylindrical shape, and also has a retainer confirmation hole 94 and a second seal confirmation hole 95, which are each a circular through-hole, formed therein.

As shown in FIG. 11A and FIG. 11B, the cover protrusion 93 is provided on the front side Df with respect to a center of the cover 9 in the front-rear direction D, and has a circular cover hole 931 formed therein, running through the cover 9 in the height direction H.

The cover hole 931 is formed to have an inner diameter that is slightly smaller than an inner diameter of a phantom circle formed by outer edges of the blocks 831b (the phantom circle is referred to as a "second phantom circle C2") (see FIG. 11A).

As shown in FIG. 11A, the retainer confirmation hole 94 is provided in the vicinity of a corner on the rear side Db and the left side Wl of the cover 9. The retainer confirmation hole 94 has an inner diameter that is generally equal to an inner diameter of the first seal confirmation hole 82 of the seal retainer 8.

The second seal confirmation hole 95 is provided away from the retainer confirmation hole 94 by a predetermined interval in the width direction W. Specifically, the second seal confirmation hole 95 is provided at a position facing the first seal confirmation hole 82 of the seal retainer 8 in the height direction H in a state where the cover 9 is assembled to the female housing 10. The second seal confirmation hole 95 has an inner diameter that is generally equal to the inner diameter of the retainer confirmation hole 94.

That is, the retainer confirmation hole 94 and the second seal confirmation hole 95 are each located at a position, in the front-rear direction D, matching that of the first seal confirmation hole 82 of the seal retainer 8. The retainer confirmation hole 94 and the second seal confirmation hole 95 are located to be away from each other, and are also located away from an outer perimeter of the cover bottom surface portion 91 and the cover hole 931.

The cover side wall 92 stands from three outer perimeters, namely, the outer perimeters except for one perimeter along the front-rear direction D, of the cover bottom surface portion 91 having a generally rectangular shape as seen in a plan view. The cover side wall 92 has cover engaging holes 921 each running through a part thereof.

As shown in FIG. 11B and FIG. 11C, the cover engaging holes 921 each have a generally rectangular shape as seen in a front view, and is formed to run through to a predetermined height level in the height direction H from an end on the bottom side Hd of the cover side wall 92. Two cover engaging holes 921 thus configured are respectively provided at two positions corresponding to the engaging protrusions 115 in a state where the cover 9 is assembled to the female housing 10.

In this embodiment, two wire harnesses 3 are provided. Therefore, two covers 9 are provided in accordance with the number of the wire harnesses 3. The two covers 9 are lined up in the width direction W in a state of being attached to the harness holding portion 11 of the female housing 10 (see FIG. 4 and FIG. 5).

Regarding the cover 9 located on the right side Wr among the covers 9 thus lined up, the cover side wall 92 stands from the outer perimeters of the cover bottom surface portion 91 except for the outer perimeter on the left side Wl. Regarding the cover 9 located on the left side Wl, the cover side wall 92 stands from the outer perimeters of the cover bottom surface portion 91 except for the outer perimeter on the right side Wr.

In the above-described harness-side connector 1 including the elements thus configured, the female housing 10 houses the shield shells 2 and the wire harnesses 3; the housing seal 5 and the housing seal cover 6 are attached to the holding portion main body 12; the wire seals 7, the seal retainers 8 and the covers 9 are attached, in this order from the top side Hu toward the bottom side Hd, to the insertion holes 111 having the wire harnesses 3 inserted therethrough; and the shield wires 31 are drawn out from the cover holes 931 of the covers 9 (see FIG. 12).

The cover holes 931 are each formed to have the inner diameter that is slightly smaller than that of the second phantom circle C2 of the seal retainer 8 stacked on the top side Hu of the cover 9. Therefore, in a state where the cover 9 is assembled to the female housing 10, an inner circumferential surface of the cover hole 931 presses the elastic pieces 831 inward (toward the center of the shield electric wire 31) (see FIG. 13A). As a result, the elastic pieces 831 and the inner circumferential surface of the cover hole 931 hold the shield electric wire 31 at a certain position along the height direction H.

Therefore, each seal retainer 8 is not inadvertently moved with respect to the shield electric wire 31, and thus the wire seal 7 is prevented from coming off from the insertion hole 111. In addition, it is suppressed that the shield electric wire 31 to be drawn out moves with respect to the female housing 10. As a result, for example, the connection state between the harness-side connector 1 and the device-side connector 200 is stabilized.

Each cover 9 includes the retainer confirmation hole 94 and the second seal confirmation hole 95 formed therein, which are each a circular through-hole. Each seal retainer 8 includes the first seal confirmation hole 82 formed therein.

Therefore, the retainer confirmation hole 94 of the cover 9 may be visually observed from the bottom side Hd, so that the inside of the harness holding portion 11 (the top side Hu) is confirmed through the retainer confirmation hole 94 (see FIG. 13A).

In this embodiment, each seal retainer 8 is assembled on the top side Hu of the cover 9. Therefore, the seal retainer 8 is confirmed through the retainer confirmation hole 94. In this manner, the inside of the harness holding portion 11 is confirmed through the retainer confirmation hole 94. Therefore, for example, the cover 9 is prevented from being inadvertently assembled in a state where the seal retainer 8 is not assembled.

The second seal confirmation hole 95 provided in each cover 9 is in communication with the first seal confirmation hole 82 of the seal retainer 8 in the height direction H. Therefore, the second seal confirmation hole 95 may be confirmed from the bottom side Hd, so that the inside (the top side Hu) of the seal retainer 8 is confirmed through the first seal confirmation hole 82 (see FIG. 13B). fs

In this embodiment, each wire seal 7 is assembled on the top side Hu of the seal retainer 8. Therefore, the wire seal 7 is confirmed through the first seal confirmation hole 82 and the second seal confirmation hole 95. In this manner, the inside of the seal retainer 8 is confirmed through the first seal confirmation hole 82 and the second seal confirmation hole 95. Therefore, for example, the cover 9 is prevented from being inadvertently assembled in a state where the wire seal 7 is not assembled.

As described above, the first seal confirmation hole 82 runs through each seal retainer 8, and the retainer confirmation hole 94 and the second seal confirmation hole 95 run through the cover bottom surface portion 91. However, the first seal confirmation hole 82 is located away from the outer perimeter of the seal retainer 8 and the electric wire insertion hole 83, and the retainer confirmation hole 94 and the second seal confirmation hole 95 are located away from each other. That is, the retainer confirmation hole 94 and the second seal confirmation hole 95 are located away from the outer perimeter of the cover bottom surface portion 91 and the cover hole 931. Therefore, it is suppressed that the first seal confirmation hole 82, the retainer confirmation hole 94 and the second seal confirmation hole 95, which are each a through-hole, decrease the strength of the seal retainer 8 and the cover 9 and the water-stopping property of the wire seal 7.

Hereinafter, a connection method of the connector connection structure A will be briefly described.

First, the harness-side connector 1 is located on the front side Df of the device-side connector 200 secured to the housing 100, such that the holding portion main body 12 faces the device-side connector 200 in the front-rear direction D, and the harness-side connector 1 is moved toward the rear side Db. As a result, the hood 212 is inserted into a space formed between the outer wall 122a and the inner wall 122b, and thus the connector connection structure A is formed. At this point, the engaging lever 4 is pivoted, so that the connection state between the device-side connector 200 and the harness-side connector 1 in the connector connection structure A is maintained.

In a state where the device-side connector 200 and the harness-side connector 1 are connected to each other in this manner, the harness-side terminals 30 are respectively in contact with the device-side terminals 201. Therefore, the harness-side terminals 30 are electrically connected to an electric equipment main body located in the housing 100, and thus the device-side terminals 201 and the harness-side terminals 30 electrically connected to the shield electric wires 31 are made conductive to each other respectively.

The harness-side connector 1 thus configured is fit into the device-side connector 200, and thus terminals provided therein (the harness-side terminals 30 and the device-side terminals 201) are connected to each other. The harness-side connector 1 includes the wire harnesses 3 respectively having the harness-side terminals 30 attached to tips thereof and the female housing 10 housing the harness-side terminals 30 and the shield shells 2.

The female housing 10 includes the holding portion main body 12 having the harness-side terminals 30 and the shield shells 2 located therein, and also includes the harness holding portion 11 being in communication with the holding portion main body 12 and holding the wire harnesses 3. The female housing 10 has the insertion holes 111 formed therein, through which the wire harnesses 3 are respectively inserted.

In addition, the harness-side connector 1 includes the wire seals 7 attached to the harness holding portion 11 to seal the gaps between the wire harnesses 3 and the harness holding portion 11, the seal retainers 8 attached to the harness holding portion 11 to respectively inhibit the wire seals 7 from coming off from the harness holding portion 11, and the covers 9 attached to the harness holding portion 11 to respectively cover the seal retainers 8.

The covers 9 each have the retainer confirmation hole 94 and the second seal confirmation hole 95 formed therein, through which the seal retainer 8 and the wire seal 7 attached to the harness holding portion 11 are confirmed from the outside (from the bottom side Hd) in an attachment direction in which the seal retainer 8 and the wire seal 7 are attached to the harness holding portion 11. In addition, the seal retainers 8 each have the first seal confirmation hole 82 formed therein, through which the wire seal 7 is confirmed. The second seal confirmation hole 95 is configured such that the wire seal 7 is confirmed through the first seal confirmation hole 82 and the second seal confirmation hole 95.

As a result, the wire seals 7 and the retainers 8 are prevented from being left unassembled to the female housing 10.

In more detail, the harness holding portion 11, which forms the female housing 10 together with the holding portion main body 12 having the harness-side terminals 30 and the shield shells 2 located therein and also holds the wire harnesses 3, has the insertion holes 111 formed therein, through which the wire harnesses 3 are respectively inserted.

The wire seals 7 sealing the gaps between the wire harnesses 3 and the harness holding portion 11, the seal retainers 8 respectively inhibiting the wire seals 7 from coming off from the harness holding portion 11, and the covers 9 respectively covering the seal retainers 8 are attached to the harness holding portion 11.

The covers 9 each have the retainer confirmation hole 94 and the second seal confirmation hole 95 formed therein, through which the seal retainer 8 and the wire seal 7 attached to the harness holding portion 11 are confirmed from the outside (from the bottom side Hd) in the attachment direction in which the seal retainer 8 and the wire seal 7 are attached to the harness holding portion 11. The seal retainers 8 each have the first seal confirmation hole 82 formed therein, through which the wire seal 7 is confirmed. The second seal confirmation hole 95 is configured such that the wire seal 7 is confirmed through the first seal confirmation hole 82 and the second seal confirmation hole 95. Therefore, in a state where the assembly of the female housing 10 is completed, each wire seal 7 and each seal retainer 8 located in the female housing 10 are confirmed from the outside of the harness-side connector 1 through the retainer confirmation hole 94 and the second seal confirmation hole 95.

That is, if at least one of the wire seal 7 and the seal retainer 8 is not confirmed through the retainer confirmation hole 94 and the second seal confirmation hole 95, the at least one of the wire seal 7 and the seal retainer 8 is not assembled to the female housing 10. Therefore, the wire seal 7 and the seal retainer 8 are prevented from being left unassembled to the female housing 10. Thus, a situation is prevented where the harness-side connector 1 having the wire seal 7 or the seal retainer 8 left unassembled thereto is used and as a result, water is inadvertently allowed to enter the inside of the harness-side connector 1 to cause an inconvenience such that shortcircuiting or the like.

The first seal confirmation hole 82 runs through the seal retainer 8 in the attachment direction (in the height direction H). Therefore, the wire seal 7 is confirmed through the first seal confirmation hole 82 having a simple configuration.

The retainer confirmation hole 94 and the second seal confirmation hole 95 are each formed to be like a window, through which the wire seal 7 and the seal retainer 8 are visually recognized from the outside in the attachment direction (from the bottom side Hd). Such a shape of the window suppresses decrease in the strength of the cover 9 as compared with the case where the retainer confirmation hole 94 and the second seal confirmation hole 95 are formed by cutting out parts of the cover 9.

The retainer confirmation hole 94 and the second seal confirmation hole 95 run through the cover 9 in the attachment direction (in the height direction H). Therefore, the wire seal 7 and the seal retainer 8 are confirmed through the retainer confirmation hole 94 and the second seal confirmation hole 95 each having a simple configuration.

The retainer confirmation hole 94 and the second seal confirmation hole 95, running through the cover 9 in the attachment direction (in the height direction H), allow a stable waterproofing property to be guaranteed without the water-stopping property provided by the wire seals 7 being decreased, unlike, for example, confirmation holes extending in a direction in which the harness holding portion 11 and the wire seals 7 attached to the harness holding portion 11 contact each other (in the width direction W).

The seal retainers 8 each have the first seal confirmation hole 82 formed therein. The covers 9 each have the retainer confirmation hole 94 formed therein, through which the seal retainer 8 is confirmed, and also each have the second seal confirmation hole 95 formed therein, which is configured such that the wire seals 7 is confirmed through the first seal confirmation hole 82 and the second seal confirmation hole 95.

As a result, the wire seal 7 is confirmed from the outside through the second seal confirmation hole 95 provided in the cover 9 and the first seal confirmation hole 82, and the seal retainer 8 is confirmed from the outside through the retainer confirmation hole 94. Therefore, the retainer confirmation hole 94 and the first seal confirmation hole 82 allow the seal retainer 8 and the wire seal 7 to be confirmed independently from each other. Thus, it is confirmed with certainty that the wire seal 7 and the seal retainer 8 are attached to the inside of the harness holding portion 11.

Two wire harnesses 3 are provided, and two wire seals 7, two seal retainers 8 and two covers 9 are provided in accordance with the number of the wire harnesses 3. Therefore, the female housing 10 is assembled easily.

In more detail, each one of the wire harnesses 3 is inserted into each one of the plurality of wire seals 7, each one of the plurality of seal retainers 8 and each one of the plurality of covers 9, provided by a number in accordance with the number of the wire harnesses 3, and thus the seals 7, the seal retainers 8 and the covers 9 are attached to the female housing 10 in the attachment direction (in the height direction H). Therefore, as compared with the case where the plurality of wire harnesses 3 are inserted through one wire seal 7, one seal retainer 8 and one cover 9 for assembly, the operability of the wire seals 7, the seal retainers 8 and the covers 9 is improved and thus the ease of assembly of the harness-side connector 1 is improved.

The engaging protrusions 115 engaged with each cover 9 to secure the cover 9 to the female housing 10 are provided. As a result, the cover 9 is attached to, and secured to, the female housing 10 easily. The engaging protrusions 115 may be disengaged, so that the cover 9 attached to the female housing 10 is detached.

Therefore, in the case where it is found out that the wire seal 7 or the seal retainer 8 is left unassembled by the confirmation made by use of the retainer confirmation hole 94 and the second seal confirmation hole 95, the cover 9 is detached from the female housing 10 and the wire seal 7 or the seal retainer 8 is attached easily in the attachment direction (in the height direction H).

The wire harnesses 3 each include the shield layer 34 enclosing the conductive core wire 32, and the female housing 10 houses the shield shells 2 each enclosing the harness-side terminal 30. The shield layer 34 and the shield shell 2 are conductive to each other.

In the above-described manner, the harness-side connector 1 of an inner shield type is provided.

Particularly in the case of the inner shield-type harness-side connector 1, the gap between the shield shell 2 and the female housing 10 is not sealed, unlike in the case of an outer shield-type connector, in which a shield shell encloses an outer surface of the harness-side connector. Therefore, the wire seal 7 attached to the inside of the female housing 10 in the attachment direction (in the height direction H) to seal the gap, and the seal retainer 8 preventing the wire seal 7 from coming off, need to be provided additionally. However, the wire seal 7 and the seal retainer 8 attached to the female housing 10 are confirmed from the outside (from the bottom side Hd). Therefore, the wire seal 7 and the seal retainer 8 are prevented from being left unassembled.

The counterpart connector according to the present invention corresponds to the device-side connector 200 in the embodiment; and similarly,

the terminal corresponds to the harness-side terminal 30 or the device-side terminal 201;

the connector corresponds to the harness-side connector 1;

the electric wire corresponds to the wire harness 3;

the housing corresponds to the female housing 10;

the terminal housing corresponds to the holding portion main body 12;

the electric wire holding portion corresponds to the harness holding portion 11;

the electric wire insertion hole corresponds to the insertion hole 111;

the seal corresponds to the wire seal 7;

the seal retainer corresponds to the seal retainer 8;

the cover corresponds to the cover 9;

the attachment direction corresponds to the height direction H;

the confirmation portion and the visual recognition window respectively correspond to the retainer confirmation hole 94 and the second seal confirmation hole 95;

the seal confirmation portion and the retainer-side seal confirmation portion correspond to the first seal confirmation hole 82;

the cover-side retainer confirmation portion corresponds to the retainer confirmation hole 94;

the cover-side seal confirmation portion corresponds to the second seal confirmation hole 95;

the engaging securing portion corresponds to the engaging protrusion 115,

the conductor corresponds to the conductive core wire 32;

the shield layer corresponds to the shield layer 34; and

the shield shell corresponds to the shield shell 2.

However, the present invention is not limited only to having the configuration described in the above-described embodiment, and may be carried out in any of various other embodiments.

For example, the retainer confirmation holes 94, the second seal confirmation holes 95 and the first seal confirmation holes 82 are through-holes in the above description, but are not limited thereto. For example, the retainer confirmation holes 94, the second seal confirmation holes 95 and the first seal confirmation holes 82 may be respectively formed by the wire seals 7, the seal retainers 8 and the covers 9 being partially cut out. Alternatively, the covers 9 and the seal retainers 8 may be partially or entirely formed of a highly visually recognizable material. In addition, the retainer confirmation holes 94, the second seal confirmation holes 95 and the first seal confirmation holes 82 are circular, but are not limited thereto. For example, the retainer confirmation holes 94, the second seal confirmation holes 95 and the first seal confirmation holes 82 may be polygonal.

The retainer confirmation holes 94, the second seal confirmation holes 95 and the first seal confirmation holes 82 are visually confirmed in the above description, but may alternatively be confirmed by any of various methods including confirmation by image processing and confirmation of positions by use of laser light, a probe or the like. In such a case, for example, the wire seals 7, the seal retainers 8 and the covers 9 may have different colors, or may be formed of different materials.

The second seal confirmation holes 95 are concentric with the first seal confirmation holes 82, but are not limited thereto as long as the wire seals 7 are confirmed.

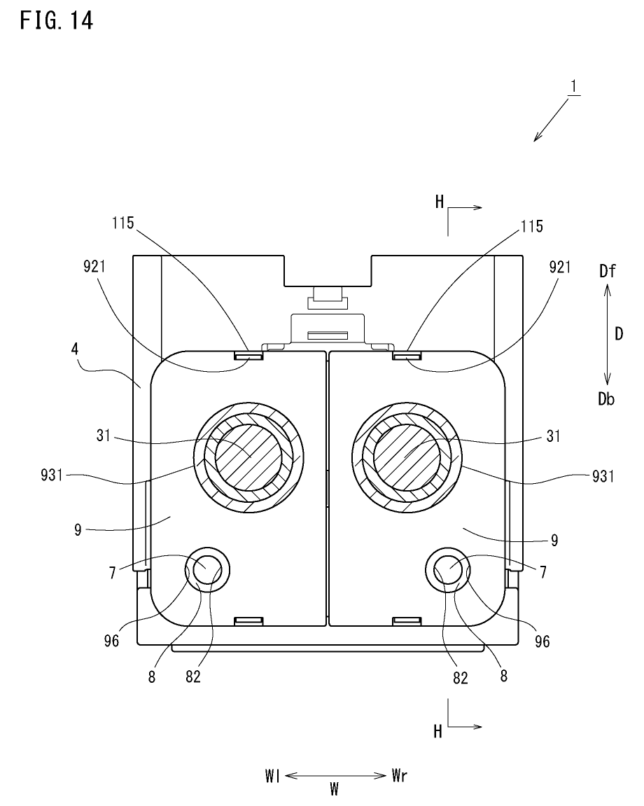

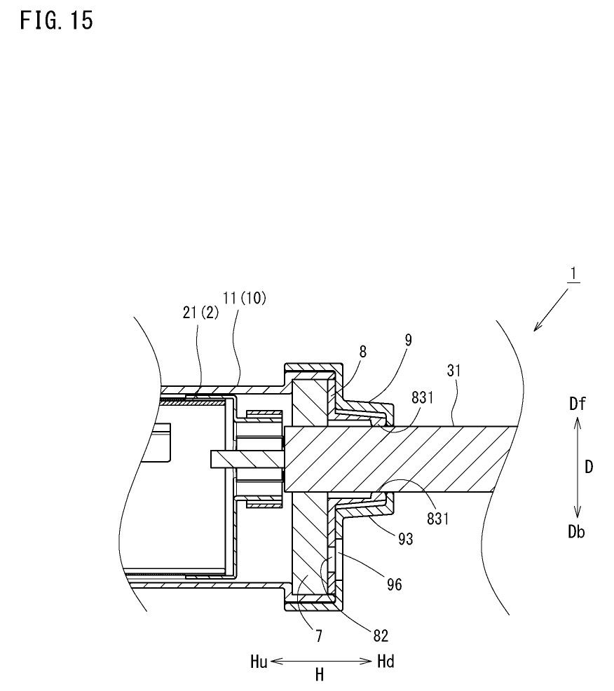

In the above description, the covers 9 each have two through-holes (the second seal confirmation hole 95 and the retainer confirmation hole 94), and it is confirmed through these two holes that the wire seal 7 and the seal retainer 8 are attached, respectively. Alternatively, as shown in FIG. 14 and FIG. 15, the covers 9 may each have one through-hole 96 formed therein at a position that corresponds to the first seal confirmation hole 82 of the seal retainer 8 in an assembled state.

FIG. 14 is a schematic bottom view of a harness-side connector 1 in another embodiment, and FIG. 15 is a cross-sectional view of FIG. 14 taken along line H-H.

Specifically, the through-hole 96 may be formed to be larger than the first seal confirmation hole 82 of the seal retainer 8, so that as shown in FIG. 14 and FIG. 15, both of the wire seal 7 and the seal retainer 8 are confirmed to be attached through one through-hole 96. In addition, as compared with the case where each cover 9 has two through-holes, the processibility of the covers 9 is improved.

The through-hole 96 is configured to be concentric with the first seal confirmation hole 82, but is not limited thereto as long as the wire seal 7 is confirmed. The through-hole 96 may have any appropriate shape as long as both of the wire seal 7 and the seal retainer 8 are confirmed to be attached through the through-hole 96.

In the above description, the wire seals 7, the seal retainers 8 and the covers 9 are provided by a number in accordance with the number of the plurality of wire harnesses 3. Alternatively, one wire seal 7 having the seal holes 71 provided by a number in accordance with the number of the wire harnesses 3, one seal retainer 8 having the electric wire insertion holes 83 provided by a number in the number in accordance with the number of the wire harnesses 3, or one cover 9 having the cover holes 931 provided by a number in accordance with the number of the wire harnesses 3 may be used.

### REFERENCE SIGNS LIST

1 ... harness-side connector

2 ... shield shell

3 ... wire harness

7 ... wire seal

8 ... seal retainer

9 ... cover

10 ... female housing

11 ... harness holding portion

12 ... holding portion main body

31 ... shield electric wire

32 ... conductive core wire

34 ... shield layer

82 ... first seal confirmation hole

94 ... retainer confirmation hole

95 ... second seal confirmation hole

111 ... insertion hole

115 ... engaging protrusion

200 ... device-side connector

201 ... device-side terminal

H ... attachment direction

1. A connector to be fit into a counterpart connector to allow terminals provided in the connector and the counterpart connector to be connected to each other, the connector comprising:
an electric wire having a terminal attached to a tip thereof; and
a housing having the terminal housed therein,
wherein:
the housing includes:
a terminal housing having the terminal located therein, and
an electric wire holding portion being in communication with the terminal housing and holding the electric wire,
the connector further comprising:
a seal having an electric wire insertion hole formed therein, through which the electric wire is inserted, the seal being attached to the electric wire holding portion to seal a gap between the electric wire and the electric wire holding portion,
a seal retainer attached to the electric wire holding portion to inhibit the seal from coming off from the electric wire holding portion, and
a cover attached to the electric wire holding portion to cover the seal retainer,
the cover has a confirmation portion formed therein, through which the seal retainer and the seal attached to the electric wire holding portion are confirmed from the outside of the connector in an attachment direction in which the seal retainer and the seal are attached to the electric wire holding portion,
the seal retainer has a seal confirmation portion formed therein, through which the seal is confirmed, and
the confirmation portion is configured such that the seal is confirmed through the confirmation portion and the seal confirmation portion.

2. The connector according to claim 1, wherein the seal confirmation portion runs through the seal retainer in the attachment direction.

3. The connector according to claim 1, wherein the confirmation portion is a visual recognition window through which the seal is visually recognized from the outside of the connector in the attachment direction.

4. The connector according to claim 3, wherein the visual recognition window runs through the cover in the attachment direction.

5. The connector according to claim 1, wherein:
the seal confirmation portion provided in the seal retainer is a retainer-side seal confirmation portion, and
the confirmation portion includes:
a cover-side retainer confirmation portion through which the seal retainer is confirmed, and
a cover-side seal confirmation portion through which the seal is confirmed via the retainer-side seal confirmation portion.

6. The connector according to claim 1, wherein the connector includes:
a plurality of the electric wires, and
a plurality of the seals, a plurality of the seal retainers, and a plurality of the covers provided by a number in accordance with the number of the plurality of electric wires.

7. The connector according to claim 6, further comprising engaging securing portions respectively engaged with the covers to secure the covers to the housing.

8. The connector according to claim 6, wherein:
the electric wires each include a shield layer enclosing a conductor,
the housing houses shield shells respectively enclosing the terminals, and
the shield layers and the shield shells are respectively conductive to each other.
